(19) United States
(12) Patent Application Publication
(10) Pub. No.: US 2016/0289093 A1
(43) Pub. Date: Oct. 6, 2016

(54) A PROCESS FOR REMOVING UREA FROM WATER

(71) Applicants: Philippe Rychen, Muespach-le-haut (FR); Beate Scheiffelen, Weissach (DE); Tamara Frank, Stuttgart (DE)

(72) Inventors: Philippe Rychen, Muespach-le-haut (FR); Beate Scheiffelen, Weissach (DE); Tamara Frank, Stuttgart (DE)

(21) Appl. No.: 15/035,745

(22) PCT Filed: Nov. 11, 2014
(86) PCT No.: PCT/EP2014/074187

§ 371 Date: May 10, 2016

Related U.S. Application Data
(60) Provisional application No. 61/902,576, filed on Nov. 11, 2013.

(51) Int. Cl. C02F 1/42; C02F 1/72

(52) U.S. Cl. CPC C02F 1/42; C02F 1/72; C02F 2001/425; C02F 2103/04

(57) ABSTRACT

A process for removing urea from water, the concentration of urea in the feed water being less than 1 ppm, the process comprising the steps of adding a nitrite ion to the water and of then passing the water through a strong cation exchange resin in an ion exchange column. The molar ratio of nitrite to urea is preferably between 50 and 1500. The urea reacts with the nitrite to form dissolved nitrogen and carbon dioxide gases, and ammonium. The ammonium is removed in the ion exchange column. There may be two columns in series. The nitrite may be added in the form of a sodium nitrite salt, nitrous acid, or nitrogen dioxide gas. The excess of nitrite present in the treated water may be removed with an anion exchange resin, by reaction with an oxidant, or with a reverse osmosis treatment step. Regeneration of the column is triggered by a measurement of the pH or of the conductivity and is conducted with an acidic solution.

### BACKGROUND

Urea (CO(NH₂)₂) is a very small molecule, very polar and highly dissolved in water. This makes it difficult to be removed at low concentrations (up to 1000 ppb, parts per billion). In most natural waters (well, drinking, and surface) and in recycled wastewater (municipal industrial and agricultural water), urea can be present, depending especially on seasonal agricultural run off, in the range of 1-100 ppb.

For ultrapure water (UPW) production, especially for use in the manufacture of semiconductor wafers, urea is a very critical contaminant, for during semiconductor device production the urea hydrolyses on the surface, producing mainly prohibited ammonia, an ionic compound.

The amount of reduction of urea in conventional UPW processes is very low and not sufficient to bring the urea down to acceptable levels. Bio-filters can somewhat handle urea, but it is very difficult to control how the bio-filters will work at these low urea concentration levels. Chemical processes, like oxidation with Chlorine, Bromine followed by adsorption, reverse osmosis, and so on, are well known for reducing urea, but expensive in capital and operating costs.

It is also known to reduce urea levels with a nitrite ion (NO₂—), as a salt like NaNO₂ (sodium nitrite), Nitrous acid (HNO₂) or NO₂ gas, but at these low concentrations, for the urea is too dispersed to produce sufficient reactions to convert the urea to more easily removable elements or compounds.

Currently, UPW processes include the steps of multimedia filtration, activated carbon filtration, cation exchange resin columns, degassing, anion exchange resin columns, and then reverse osmosis which constitutes a standard pre-treatment process group of a total UPW process.

### SUMMARY

The process of this disclosure overcomes partly or totally the drawbacks of existing processes by removing 85-95% of the low concentration urea in each process step of this disclosure.

More particularly, it has been discovered that in a conventional process, the feed water to the cation exchange vessels containing urea in trace levels (1-1,000 ppb) will adsorb very slightly on strong acid ion exchange resins. This is due to the fact that urea is a very weak base molecule (pKb=1.5 E-14) and the functional groups of the resins (R—SO₃—H+) have a pKa of approximately 0.7. Resins with higher DVB (Divinylbenzene) show slightly higher adsorption capacities. At these trace levels, the adsorption capacity is in the range of 5-20% of the total resin capacity for a water containing 5 meq/L cations (Ca, Mg, Na, K, NH₄). With this increased concentration of the urea on the resin it has been discovered that a nitrite ion (NO₂), as a salt like NaNO₂ (sodium nitrite), Nitrous acid (HNO₂) or NO₂ gas, can now react with and oxidize the urea, and convert it to more easily removable elements or compounds.

In summary, the process of this disclosure adds to a UPW process the step of using a strong acid ion exchange resin, a preceding step of adding a nitrite to the feed water of an existing cation exchange resin unit, the nitrite being added by a dosing unit for NO₂, HNO₂, or NO₂. More particularly, the process of this disclosure is a process for removing urea in concentrations of less than 1000 parts per billion from a feed, the process comprising the steps of dosing the feed with a nitrite ion and then passing the dosed feed through a strong anion exchange resin in an exchange column.

### DETAILED DESCRIPTION

More particularly, the improved process of this disclosure includes one, or two cation exchange columns in series, each filled with strong acidic cation exchange resin type R—SO₃—H+ (Polystyrene cross linked with DVB). The ion exchange resins are loaded with cations from raw water (Calcium, Magnesium, sodium, Potassium, Ammonium, etc.) and replaced with hydronium (H+).

The process of this disclosure adds nitrite ion (NO₂—), as a salt like NaNO₂ (sodium nitrite), Nitrous acid (HNO₂) or NO₂ gas, through a dosing device, to the feed water in front of the cation exchange vessel or vessels, or in front of each vessel. The molar ratio of NO₂ to urea should be between 50 and 1500, ideally between 100 and 700. The reaction that then takes place on the strong anion exchange resin is:

CO(NH₂)₂+HNO₂+H⁺→N₂+CO₂+NH₄⁺+H₂O

The produced ammonium (NH₄+) during reaction on the resin bead is trapped on the ion exchange resin. The produced gases CO₂ and N₂ are dissolved in water under pressure and released during depressurizing the water. The combination of the nitrite ion together with the strong acidic cation exchange resin is hereafter referred to as the process column.

The kinetics of the reaction can be increased by increasing the temperature of the feed water up to 30-60° C. A heat recovery system can also be added to the outlet water to enhance the system efficiency, and to lower the water temperature from 40-50° C. to 20-25° C. Heating the feed water also reduces the resin contact time, so a smaller resin vessel can be used.

The excess NO₂ fed into the process will be trapped in a following anion exchange resin vessel, one that is normally present downstream in a UPW-Pre-treatment process chain. If an anion exchange resin vessel is not present, the excess NO₂ can also be removed by a downstream reverse osmosis process (RO). On the wastewater side, remaining NO₂ ions can be destroyed with sodium hypochlorite (bleach) or hydrogen peroxyde or anion exchange resins.

The process columns of this disclosure are equipped with a pH measurement. The ion exchange cycle and the urea oxidation reaction changes the pH of the outlet water. At increasing pH at a given set point, the process needs to be stopped and a regeneration process with acid (HCl, H₂SO₄, or HNO₃) started, followed by a water rinse. The regeneration can be co-current regeneration or preferably counter-current regeneration. The same process control can also being done by a conductivity/resistivity measurement, for the conductivity decreases and resistivity increases at breakthrough at the end of the process before regeneration.

The improved process of this disclosure needs only one strong acid action exchange resin column (CAX), but it is beneficial to have a second CAX polishing filter in series with a first CAX.

The following table illustrates an example of the results of the use of the process of this disclosure.

Feed water: 3 meq./L cations - 200 ppb Urea - 50 ppm NO₂

| After first column | | After second column |
|---|---|---|
| 20-50 ppb Urea | | <5 ppb urea |
| pH = 3 | conductivity 800 microS/cm | pH = 3 |
| at breakthrough | | |
| 80 ppb urea | | <5 ppb urea |
| pH = 5 | conductivity 400 microS/cm | pH = 3 |

Benefits

Each process column of this disclosure is able to have a urea removal efficiency of 85-95% over a complete ion exchange cycle. When two process columns are placed in series, the first process column acts as a working filter and the second process column acts as a polishing filter, benefiting from the remaining excess NO₂ present in the water.

Various other features of this disclosure are set forth in the following claims.

1. A process for removing urea in concentrations of less than 1000 parts per billion from feed water, the process comprising the step of: providing the feed water to one or more ion exchange columns in series filled up with strong acid cation exchange resins and an addition of a nitrite ion (NO₂—) by adding at least one of a salt like NaNO₂, Nitrous acid (HNO₂) or NO₂ gas in front of the ion exchange resin column.

2. A process in accordance with claim 1 wherein the ion exchange resins are loaded with cations from raw water and replaced with hydronium during regeneration.

3. A process in accordance with claim 1 wherein the ammonium ions which are partially produced by the reaction of urea with the nitrite ion is at same time removed by the resin during saturation and replaced with hydronium during regeneration.

4. A process in accordance with claim 1 wherein the process includes the step of controlling the process by one of either electrical conductivity or pH to trigger a regeneration of the resin phase with acidic solutions.

5. A process in accordance with claim 1 wherein the column is regenerated with acid and rinsed out with water.

6. A process in accordance with claim 1 wherein the excess of nitrite ion present in the water added in front of the ion exchange columns is removed by one of a following anion exchange resin or reaction with hypochlorite solutions or hydrogen peroxide or other oxidant or a downstream reverse osmosis process.

7. A process according to claim 1, and further including the step of heating the dosed feed up to at least about 30° C.

8. A process according to claim 1 wherein the dosed molar ratio of NO₂ to urea is between 50 and 1500.

9. A process according to claim 8 wherein the dosed molar ratio of NO₂ to urea is between 100 and 700.

10. A process for removing urea in concentrations of less than 1000 parts per billion from a feed, the process comprising the steps of:
dosing the feed with a nitrite ion (NO₂—) by adding at least one of a salt like NaNO₂, Nitrous acid (HNO₂) or NO₂ gas; and
then passing the dosed feed through a strong acid cation exchange resin in an exchange column.

11. A process according to claim 10 wherein the dosed molar ratio of NO₂ to urea is between 50 and 1500.

12. A process according to claim 11 wherein the dosed molar ratio of NO₂ to urea is between 100 and 700.

13. A process according to claim 12, and further including the step of heating the feed up to at least about 30° C.

14. A process according to claim 13 wherein the ion exchange resins are loaded with cations from raw water and replaced with hydronium during regeneration.

15. A process in accordance with claim 14 wherein the ammonium ions which are partially produced by the reaction of urea with the nitrite ion is at same time removed by the resin during saturation.

16. A process in accordance with claim 15 wherein the process includes the step of controlling the process by one of either electrical conductivity or pH to trigger a regeneration of the resin phase with acidic solutions.

17. A process in accordance with claim 16 wherein the column is regenerated with acid and rinsed out with water.

18. A process in accordance with claim 17 wherein the excess of nitrite ion present in the water added in front of the ion exchange columns is removed by one of a following anion exchange resin or reaction with hypochlorite solutions or hydrogen peroxide or another oxidant or a downstream reverse osmosis process.

19. A process according to claim 3 wherein the excess of nitrite ion present in the water added in front of the ion exchange columns is removed by one of a following anion exchange resin or reaction with hypochlorite solutions or hydrogen peroxide or other oxidant or a downstream reverse osmosis process, and wherein the dosed molar ratio of NO₂ to urea is between 50 and 1500.

20. A process according to claim 11 wherein the ammonium ions which are partially produced by the reaction of urea with the nitrite ion is at same time removed by the resin during saturation, and wherein the excess of nitrite ion present in the water added in front of the ion exchange columns is removed by one of a following anion exchange resin or reaction with hypochlorite solutions or hydrogen peroxide or another oxidant or a downstream reverse osmosis process.
